(19) United States
(12) Patent Application Publication
(10) Pub. No.: US 2025/0145089 A1
(43) Pub. Date: May 8, 2025

(54) VEHICLE-MOUNTED BICYCLE RACK

(71) Applicant: Riley Lynn White, Hurricane, UT (US)

(72) Inventor: Riley Lynn White, Hurricane, UT (US)

(21) Appl. No.: 18/940,540

(22) Filed: Nov. 7, 2024

Related U.S. Application Data
(60) Provisional application No. 63/597,118, filed on Nov. 8, 2023.
(60) Provisional application No. 63/597,123, filed on Nov. 8, 2023.
(60) Provisional application No. 63/597,129, filed on Nov. 8, 2023.

(51) Int. Cl. B60R 9/10; B60R 9/06; B62H 3/08

(52) U.S. Cl. CPC B60R 9/10; B60R 9/06; B62H 3/08

(57) ABSTRACT

A vehicle-mounted rack includes a hitch shank, a vertical arm coupled to the hitch shank, a horizontal arm coupled to and extending from the vertical arm, and one or more bike receiving members coupled to the horizontal arm, wherein the vertical arm is configured to move on vertical axis (y-axis) in relation to the hitch shank. An electric motor may be included to control the position of the vertical arm, with the motor being removable. The vehicle-mounted rack may further include a plurality of pedal grips, wherein the pedal grips are configured to clamp onto the pedals of a bike to secure the bike to the rack.

### CROSS-REFERENCE TO RELATED APPLICATIONS

This application claims the benefit of U.S. Provisional Application Ser. No. 63/597,118, filed on Nov. 8, 2023, further claims the benefit of U.S. Provisional Application Ser. No. 63/597,123, filed on Nov. 8, 2023, and further claims the benefit of U.S. Provisional Application Ser. No. 63/597,129, filed on Nov. 8, 2023, all of which are incorporated herein by reference.

### TECHNICAL FIELD

The present disclosure relates to vehicle-mounted racks for transporting bicycles and motorcycles, among other devices.

### BACKGROUND

The desire to transport bicycles and motorcycles has steadily increased over the years. This is particularly true in light of the recent popularity of electric bicycles and motorcycles (collectively referred to as “bikes” herein). As a result, there are a number of vehicle-mounted racks that are configured to aid in the transportation of these bikes. Many racks are stationary and require a user to lift and mount their bike on the rack. While this works for some users and some bikes, many users cannot utilize these racks due to the weight of the bike or the difficulty in mounting the rack to the bike while suspended on the rack.

To overcome those limitations, adjustable racks have been developed in the prior art. These adjustable racks are manually actuated, electrically actuated, or some combination. Some racks include ramps, allowing a user to roll their bike up to the vehicle-mounted rack. However, pushing the bike up the ramp requires strength, dexterity, and may not be feasible for many users. Other racks have the ability to raise and lower while coupled to the vehicle. The main benefit of these adjustable racks is the ability to lower the rack to the ground, or proximal thereto, to allow a user to more easily mount a bike thereon without lifting or pushing their bike up a ramp. Once the bike is mounted on the adjustable rack, a user may actuate a raising mechanism to raise the rack to a safe distance from the ground during transport. While these adjustable racks have overcome some limitations, there are still several that remain.

For example, some racks require manual actuation, such as hand-turning a crank. Again, this can be difficult for many users, particularly if the load is heavy. Some racks have been configured to allow a user to couple a power drill to a bit to thereby actuate the mechanism. However, this requires a user to purchase a drill and to remember to take the drill with them when transporting the bike. Additionally, holding the drill in position while actuating the mechanism may be difficult or require strength, and safety measures may not properly restrict the drill from exceeding the drive length of the adjustable rack, which may cause damage to the rack or may unexpectedly jerk a user's grip. Further, some drills may lack the power to raise a heavy load, such as when transporting multiple bikes (or even just one motorcycle, which may weigh significantly more).

Some racks utilize the power provided by the vehicle, such as connecting to a trailer tow connector (e.g., 4-pin, 7-pin, etc.). While this can be an excellent source of power, many vehicles may not have a connector, or may lack the type of connector or adapter required to couple the rack to the vehicle power.

Further, the mechanisms for securing the bikes to the rack vary from rack to rack, with most using straps, bands, receivers, or other mechanisms for the tires. Straps can become worn, torn, or otherwise damaged, and tire mechanisms may be difficult to secure by a single user while simultaneously maintaining the bike in an upright position. Some racks use a locking bar or hook (which may be used in addition to tire straps), that is intended to secure to a frame or crossbar of the bike. However, bikes have different configurations and may not have a horizontal crossbar to easily couple to, such as a step-through bike (or motorcycle). As a result, the prior art often requires additional adapters or other mechanisms when such bikes are used.

Accordingly, there remains a need for an adjustable bike rack that is electrically actuated, but does not rely on vehicle power, and that is capable of securing bikes regardless of frame and crossbar configuration. The present disclosure seeks to solve these and other problems.

### SUMMARY OF EXAMPLE EMBODIMENTS

In some embodiments, a vehicle-mounted rack comprises a hitch shank, a vertical arm coupled to the hitch shank, a horizontal arm coupled to and extending from the vertical arm, and one or more bike receiving members coupled to the horizontal arm, wherein the vertical arm is configured to move on vertical axis (y-axis) in relation to the hitch shank. In some embodiments, an electric motor controls the position of the vertical arm. In some embodiments, the electric motor and power source is removably couplable to the vehicle-mounted rack.

In some embodiments, a vehicle-mounted rack comprises a plurality of pedal grips, wherein the pedal grips are configured to clamp onto the pedals of a bike.

### BRIEF DESCRIPTION OF THE DRAWINGS

FIG. 1 illustrates a top, right, rear perspective view of a vehicle-mounted rack;

FIG. 2 illustrates a top, left, front perspective view of a vehicle-mounted rack;

FIG. 3 illustrates a left, side elevation view of a vehicle-mounted rack;

FIG. 4 illustrates a front, right perspective view of a vehicle-mounted rack;

FIG. 5 illustrates a detailed perspective view of a control box mounted to a vehicle-mounted rack, with a portion of the control box removed;

FIG. 6 illustrates a right, side elevation cross-sectional view of a vehicle-mounted rack;

FIG. 7 illustrates a right, side elevation view of a vehicle-mounted rack with a control box decoupled therefrom;

FIG. 8 illustrates a detailed right perspective view of a vehicle-mounted rack;

FIG. 9 illustrates a top, right, rear perspective view of a vehicle-mounted rack with two bikes coupled thereto;

FIG. 10 illustrates a left, side elevation view of a vehicle-mounted rack with two bikes coupled thereto;

FIG. 11 illustrates a detailed perspective view of a pedal grip of a vehicle-mounted rack;

FIG. 12 illustrates a detailed, left, front perspective view of a pedal grip of a vehicle-mounted rack with a bike coupled thereto;

FIG. 13 illustrates a left, rear, perspective view of a pedal grip of a vehicle-mounted rack with a bike coupled thereto;

FIG. 14 illustrates a detailed perspective view of a bike receiving member decoupled from a horizontal member of a vehicle-mounted rack;

FIG. 15 illustrates a rear, right perspective view of a vehicle-mounted rack with a base coupled thereto; and

FIG. 16 illustrates a detailed perspective view of a pivot mechanism of a vehicle-mounted rack.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for an adjustable bike rack that is electrically actuated, but does not rely on vehicle power, and that is capable of securing bikes universally. The vehicle-mounted bike rack disclosed herein solves these problems and others. It should be noted that while the examples herein refer specifically to bikes (i.e., bicycles and motorcycles), other devices may likewise be transported without departing herefrom, such as wheelchairs, coolers, storage containers, or any other item a user desires to transport on the rack.

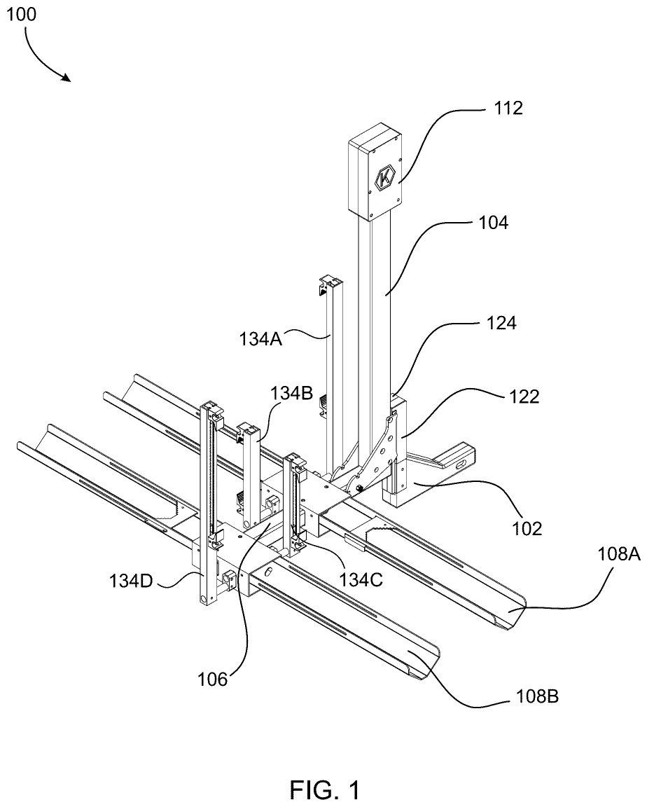

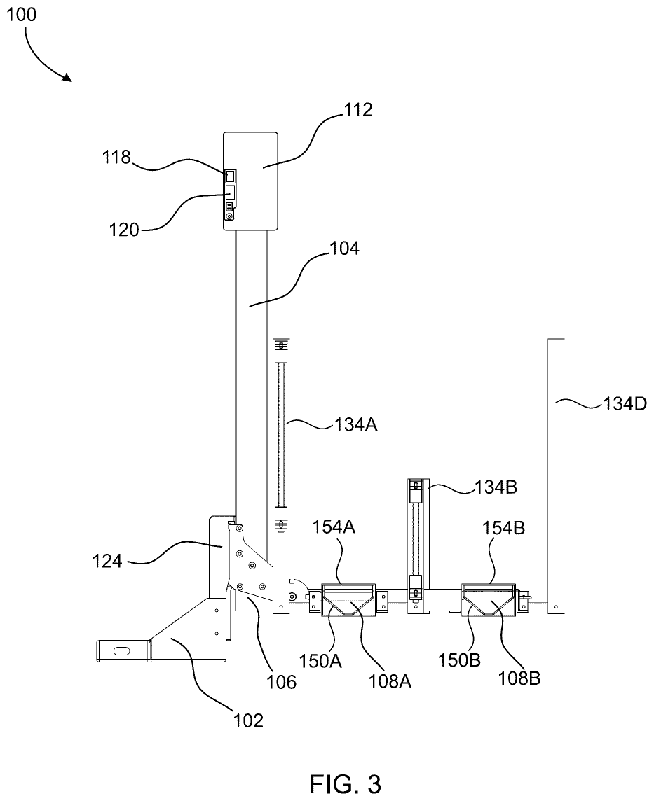

In some embodiments, as shown in FIGS. 1-4, a vehicle-mounted rack 100 comprises a hitch shank 102, a vertical arm 104 coupled to the hitch shank 102, a horizontal arm 106 coupled to and extending from the vertical arm 104, and one or more bike receiving members 108A-B coupled to the horizontal arm 104, wherein the vertical arm 104 is configured to move on vertical axis (y-axis) in relation to the hitch shank 102.

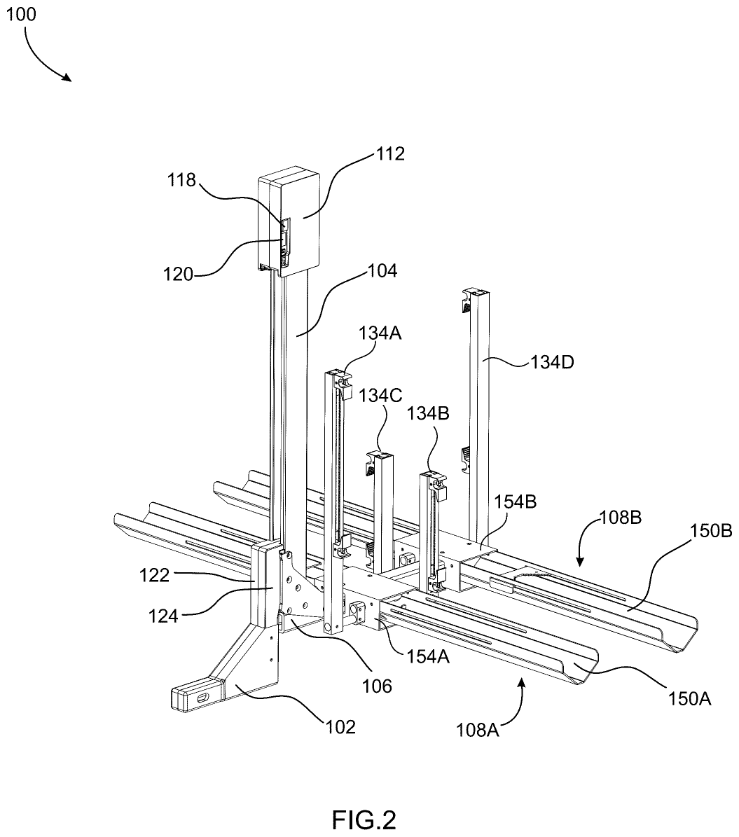

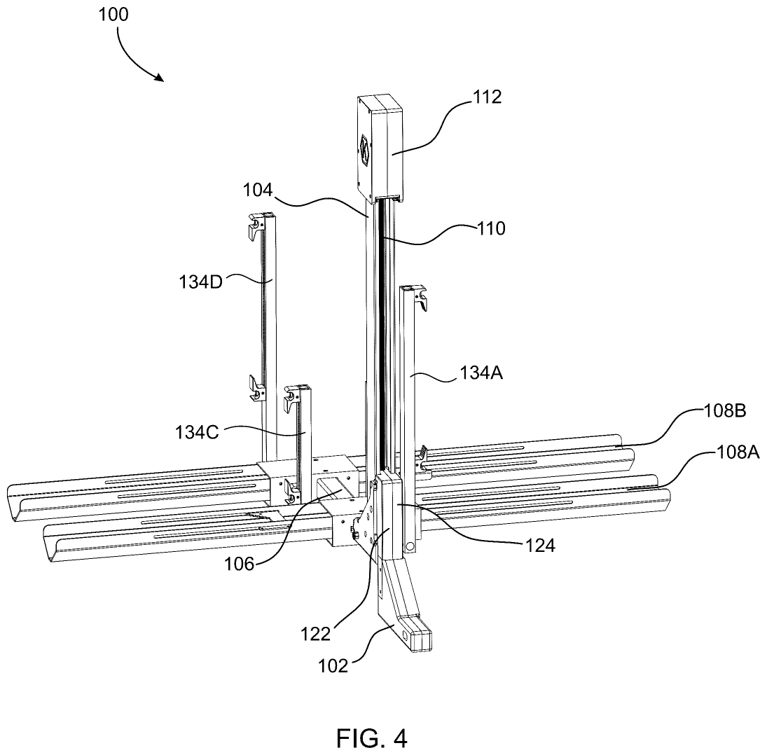

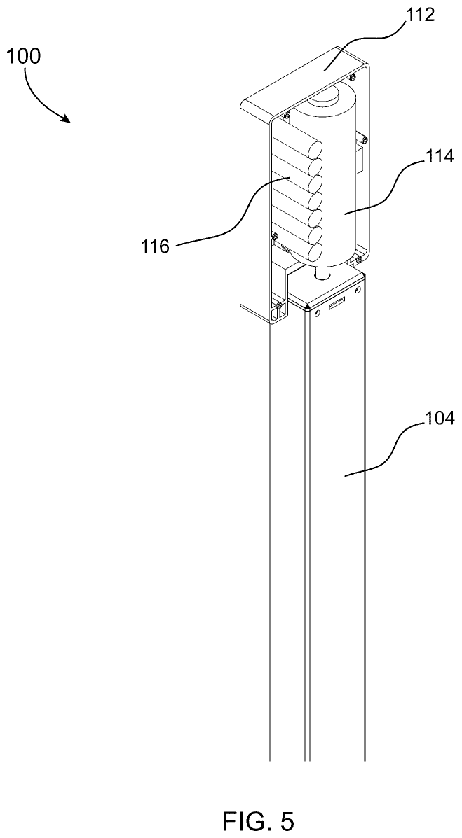

Referring to FIGS. 4-6, in some embodiments, the vertical arm 104 may comprise a threaded rod 110 configured to control the position of the vertical arm 104 in relation to the hitch shank 102. In some embodiments, the threaded rod 110 may be manually actuated, such as by using a hand crank. However, in a preferred embodiment, the threaded rod 110 is actuated via an electric motor. For example, a control box 112 may comprise an electric motor 114, one or more batteries 116, and one or more switches 118 (FIG. 2) to control the motor 114, including its direction, and in some embodiments, a battery status indicator 120.

The hitch shank 102 may comprise a first plate 122 and a second plate 124 coupled thereto, wherein the first and second plates 122, 124 comprise a threaded throat 126 through which the threaded rod 110 passes, the threaded throat 126 being complementary to the threaded rod 110. As a result of the engagement with the throat 126, when the threaded rod 110 rotates in a first direction, the threaded rod 110 travels downwardly, and when the threaded rod 110 rotates in a second direction, the threaded rod 110 travels upwardly. In some embodiments, the motor 114 may be stopped via a current restricting fuse or sensor so as to prevent hard stops or overextension. As the threaded rod 110 moves in the first and second direction, respectively, the vertical arm 104 and horizontal arm 106 likewise move. It will be appreciated that, in some embodiments, the first plate 122 and second plate 124 may be pivotably coupled to the hitch shank 102, which would allow for the vertical arm 104 to be tilted away from the vehicle to which the hitch shank 102 is coupled. This may be beneficial for a user to access an SUV hatch or truck bed more easily. Locking pins, spring-loaded pins, nuts and bolts, or other known mechanisms may be used to prevent unwanted pivoting.

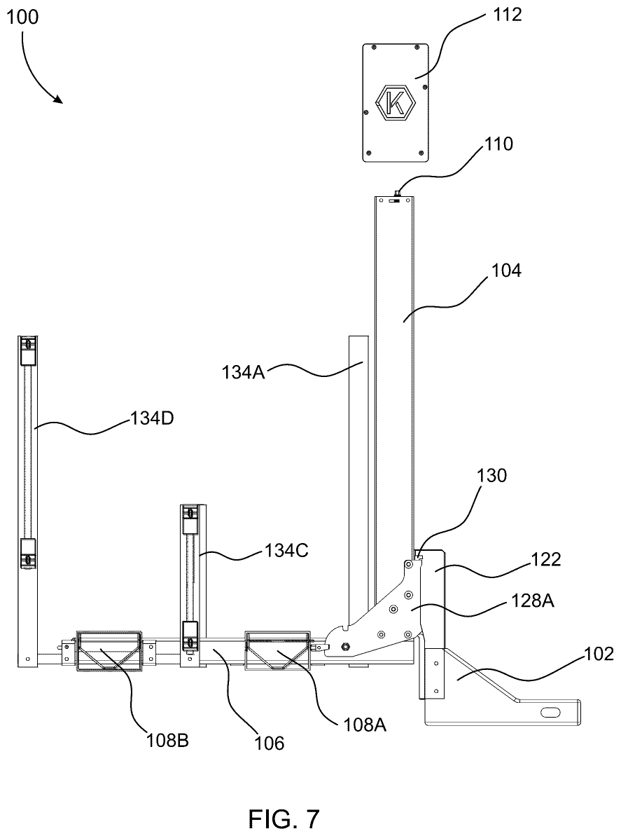

As shown in FIG. 7, the control box 112 may be removably couplable to the vertical arm 104 and threaded rod 110. This has several benefits. For example, by removing the control box 112, the weight of the motor 114 and batteries 116 is removed from the rack 100, creating less strain on the hitch shank 102. Additionally, because the control box 112 houses electronic components, a user may desire to store the control box 112 in a dry area when not in use, despite the control box 112 being water resistant. Yet another benefit is the ability to change the control box 112 in the event of a malfunction, or to upgrade the control box 112 for heavier loads. For example, and assuming the other components are rated for the weight, the control box 112 may be changed to another control box 112 having a more powerful motor, larger batteries, or other upgrades. Lastly, in the event of dead batteries or a malfunction, a user may simply remove the control box 112 to access the threaded rod 110, which may then be manually actuated using tools (e.g., drill, ratchet, pliers, etc.), hand cranks, or other mechanisms.

It will be appreciated that the control box 112 may also comprise a microcontroller and a wireless transceiver to allow for more sophisticated functionality. For example, a user may pair a smartphone (or other wireless device) to the control box 112 via the wireless transceiver using standard protocols (e.g., Bluetooth, Wi-Fi, etc.). Once paired, a user may control the position of the horizontal arm 106 using application software deployed on the smartphone. Additionally, the user may be able to obtain status information or alerts, such as battery charge status, height of the horizontal arm 106, or other parameters. In some embodiments, the control box 112 may comprise lights corresponding to the vehicle (e.g., brake lights, turn signal indicators, reverse lights, etc.) which may be controlled via the microcontroller and one or more connections and/or sensors. For example, the control box 112 may comprise an optical sensor configured to detect which lights on the vehicle are illuminated, with the corresponding lights on the control box 112 configured to thereby illuminate as well.

While a threaded rod 110 is shown and described, it will be appreciated that other linear actuators may be used without departing herefrom, such as a rack and pinion, piston and cylinder (whether hydraulic or electric), belt or chain drive, or others.

By using batteries 116 in the control box 112, a user is not required to connect to a vehicle power source. This allows a user to use the rack 100 regardless of whether they have a tow connector. Further, even if a user has a tow connector, the control box 112 has several additional benefits, including not draining the crank battery of the vehicle or otherwise relying on the vehicle engine running, while supplying the correct amount of power to the motor 114. The batteries 116 may be charged using known methods, such as by using a charging port on the control box 114. In some embodiments, the control box 112 may comprise solar panels to configured to charge the batteries 116 as well. Additionally, in some embodiments, the control box 112 may comprise lights to provide extra lighting, or to include additional lighting signals such as turn signals, brake lights, etc. When the control box 112 is removed by a user, it may also function as a handheld flashlight.

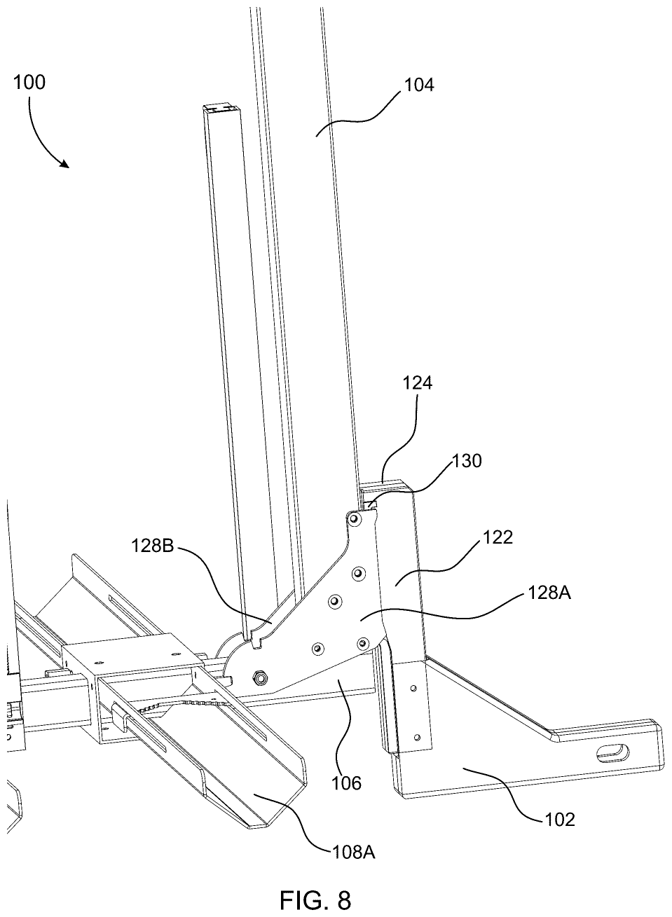

Referring to FIG. 8, the rack 100 further comprises at least one stabilization plate 128A-B for coupling the horizontal arm 106 to the vertical arm 104. Additionally, the at least one stabilization plate 128A-B may comprise a slot, groove, or other aperture on a top end for receiving a keyed protrusion 130. When the stabilization plate 128A-B is mated to the keyed protrusion 130, wobble is reduced and stability enhanced by restricting lateral motion.

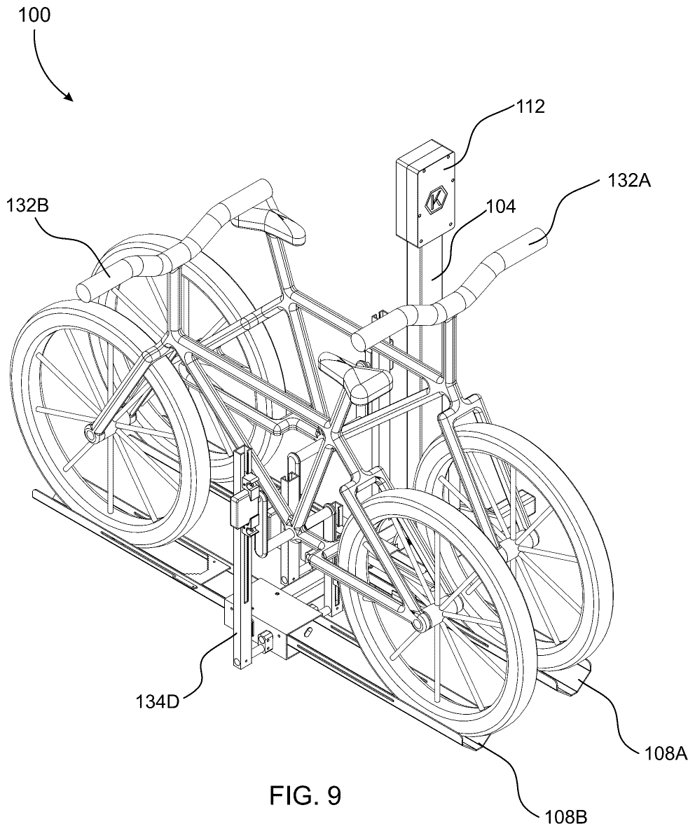

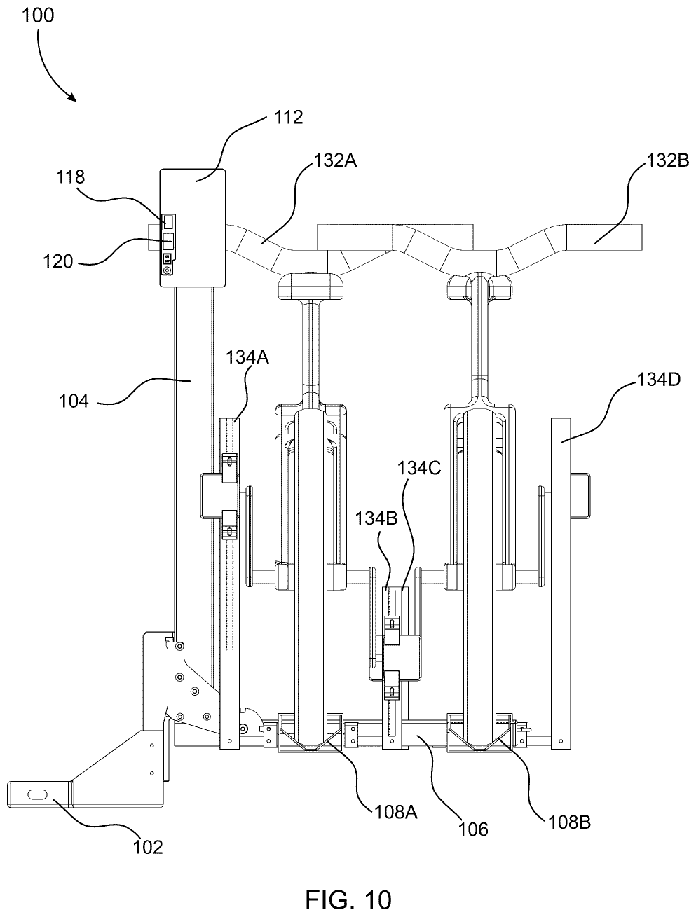

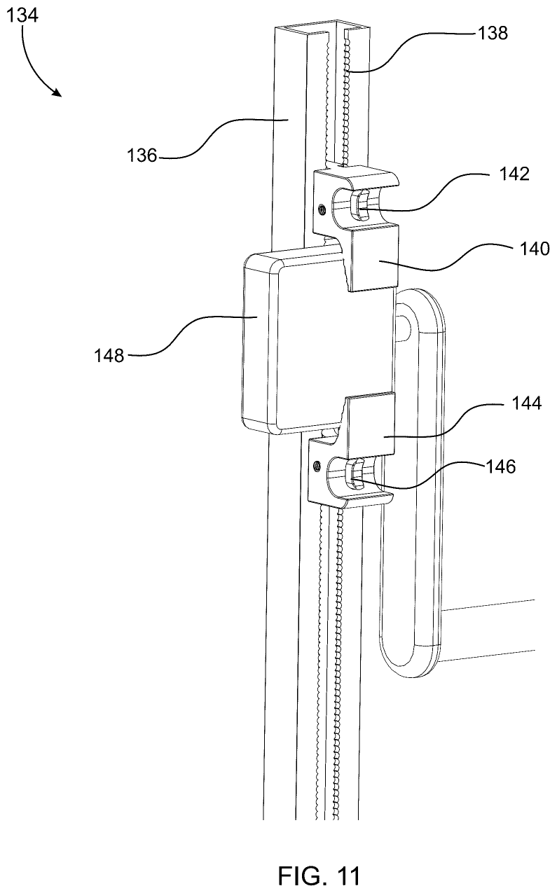

FIGS. 9-10 illustrate two bikes 132A-B secured to the bike rack 100 via pedal grips 134A-D (pedal grips may be best seen without the bikes in FIG. 1). Referring to FIG. 11, each pedal grip 134 comprises a pedal post 136 having a keyed channel 138 running vertically therein, a top clamp 140 with a release lock 142 configured to be positionable along the keyed channel 138, and a bottom clamp 144 with a release lock 146 likewise configured to be positionable along the keyed channel 138. Accordingly, a user will interpose a pedal 148 between the top clamp 140 and the bottom clamp 144, will actuate the respective release locks 142, 144 and slide each clamp 140, 144 to abut the pedal 148, and then release the respective release locks 142, 144 to thereby secure the clamps 140, 144 in the keyed channel 138, effectively clamping the pedal 148 therebetween and preventing movement of the pedal 148. To ensure the best stability, a pedal grip 134 may be coupled to each pedal of a bike. While a keyed channel 138 is shown and described, it will be appreciated that other mechanisms that allow the clamps 140, 144 to slide thereon may be used without departing herefrom.

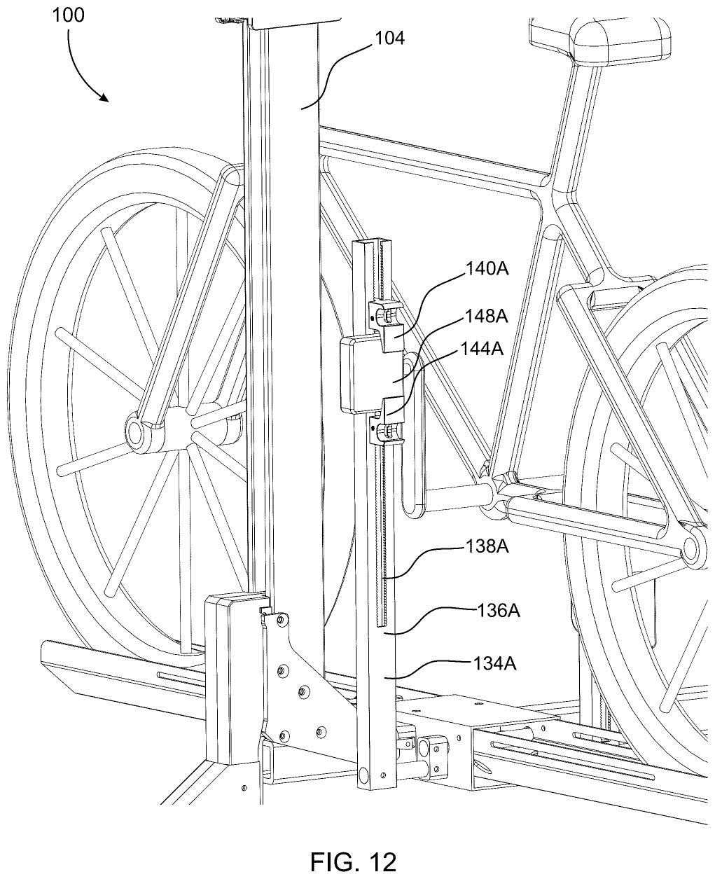

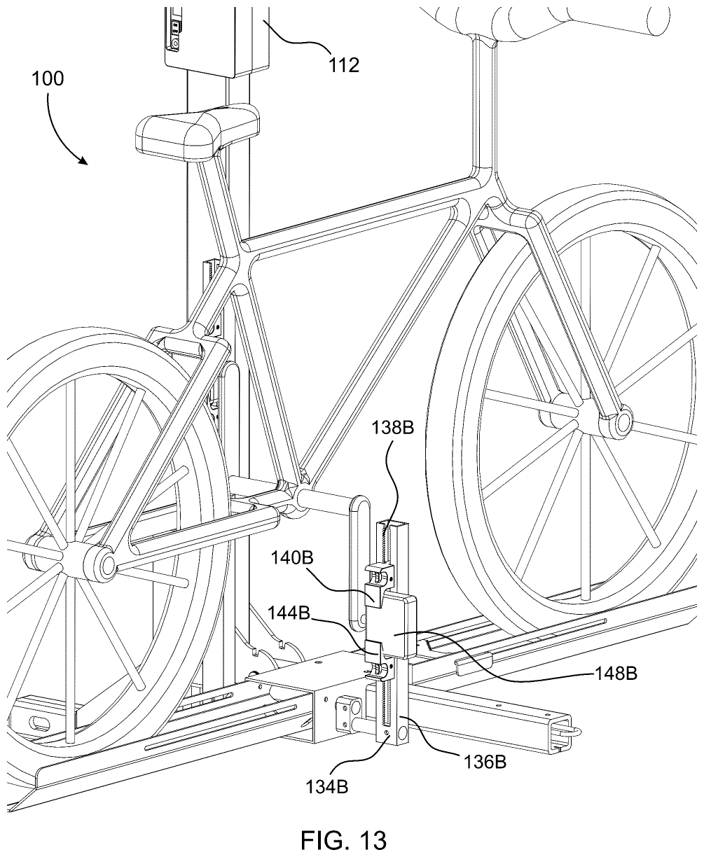

In other words, as best seen in FIGS. 12-13, a first pedal grip 134A comprises a first post 136A with a first keyed channel 138A, with a top clamp 140A and a bottom clamp 144A, with the first pedal grip 134A configured to secure a first pedal 148A at a first height corresponding the maximum rotational height of the pedal 148A. Referring to FIG. 13, with the first pedal 148A at the maximum rotational height, the second pedal 148B will be at a second, lowest rotational height. Accordingly, a second pedal grip 134B comprises a second post 136B with a second keyed channel 138B, with a second top clamp 140B and a second bottom clamp 144B, with the second pedal grip 134B configured to secure the second pedal 148B at the second, lowest height. With each pedal 148A, 148B secured using the respective pedal grips 134A, 134B, movement of the bike is prevented. Additionally, because the pedal grips 134A-B secure the bike at its second-widest point (handlebars being the first), stability is increased. This method of securement overcomes the prior art in several ways, including that it does not require attachment to the frame (which can scratch or otherwise damage the frame), does not rely solely on the tires, and is capable of securing any bike with pedals, regardless of the frame configuration or accessories coupled to the bike, such as fenders, baskets, racks, etc.

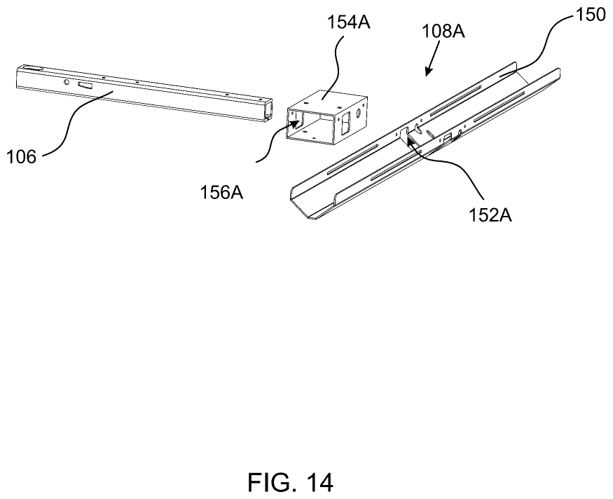

Referring back to FIGS. 9-10, the rack 100 may be configured to carry more than one bike. In other words, one or more bike receiving members 108A-B may couple to the horizontal arm 104. To accomplish this, a user couples the desired number of bike receiving members 108A-B to the horizontal arm 106. For example, as shown in FIG. 14, the bike receiving member 108A comprises a tire tray 150A having an aperture 152A configured to receive the horizontal member 106 therethrough. A bracket 154A is configured to slide over and receive the tire tray 150A prior to the horizontal arm 106 being inserted therein, the bracket 154A likewise comprising apertures 156A configured to receive the horizontal arm 106. In other words, the bracket 154A slides over the tire tray 150 and is positioned so that the tray aperture 152A aligns with the bracket aperture 156A. With the apertures 152A, 156A aligned, the horizontal arm 106 is received therethrough and secured into position using screws, bolts, or other fastening mechanisms. A rack 100 comprising multiple bike receiving members 108A-B would likewise feature multiple tire trays 150A-B with respective brackets 154A-B thereon, as shown throughout the Figures.

As shown in FIGS. 12-13, the bracket 154A is configured to receive the pedal grips 134A-B. Accordingly, it will be appreciated that the rack 100 may be configured to secure one bike or a plurality of bikes. In some instances, the number of bikes may vary depending on the length of the horizontal arm 106. In some embodiments, the horizontal arm 106 may be extended to accommodate additional bikes by coupling an extender to the end thereof (e.g., telescopic configuration for added strength at the joint), allowing a user to add additional bikes (or other objects). Each bike receiving member 108A-B ideally has a set of pedal grips 134A-B. Accordingly, two bikes will have a total of four pedal grips 134A-D (best seen in FIGS. 1 and 10), with each pedal grip 134A-D corresponding to a respective pedal of a bike.

While bike receiving members 108A-B are shown and described, it will be appreciated that such configuration is not required, and other shapes and configurations may be used, particularly when transporting other objects. For example, in one embodiment, a platform may couple to the horizontal arm 106, providing a larger surface area for receiving a variety of objects, such as storage containers, coolers, wheelchairs, scooters, etc. The platform may comprise brackets, shafts, or other mechanisms for securing the platform to the horizontal arm for use. Further, regardless of the configuration (i.e., trays, platform, etc.), each embodiment may comprise wheels or casters, which may be removably attachable to the underside, allowing the rack 100 to be easily wheeled to and from a vehicle for attachment.

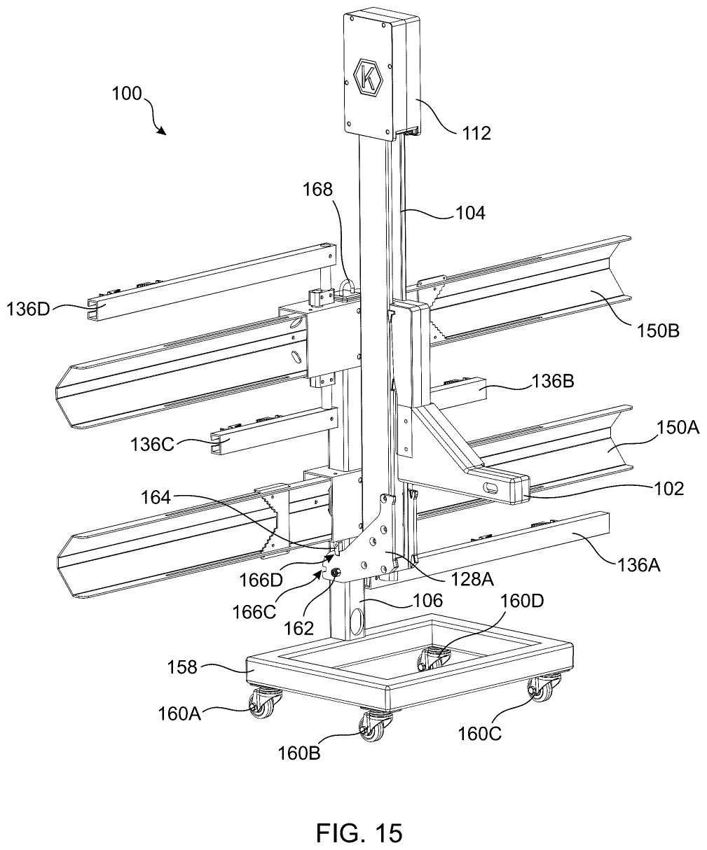

For example, referring to FIG. 15, a vehicle-mounted rack 100, in some embodiments, includes a removably attachable base 158 to facilitate easier transport and storage when not coupled to a vehicle. As shown, the removably attachable base 158 comprises a plurality of casters 160A-D (or other wheels), allowing a user to easily maneuver the vehicle-mounted rack 100 without needing other users to help. As shown, the removably attachable base 158 may couple to the horizontal arm 106. This may be accomplished by pivoting the horizontal arm 106 to a vertical position and coupling the removably attachable base 158 thereto, such as via bolts, spring-loaded locking-pins, or other mechanisms.

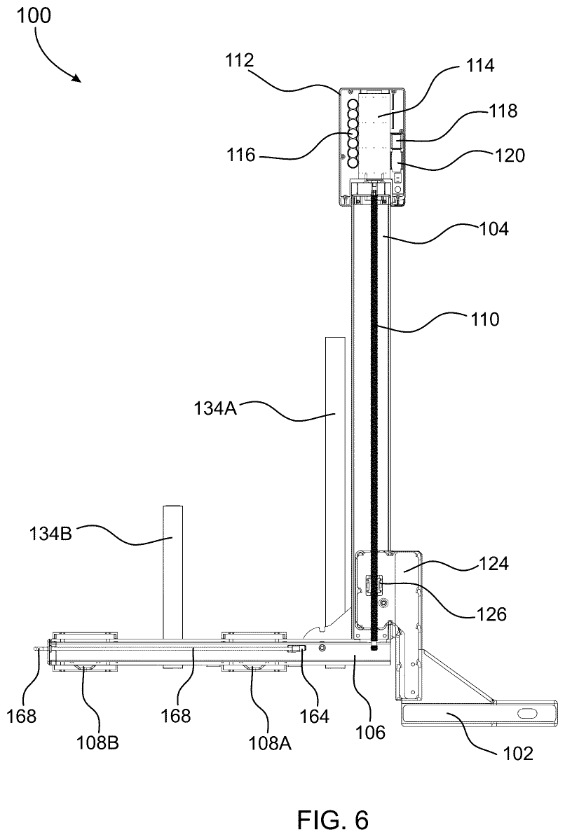

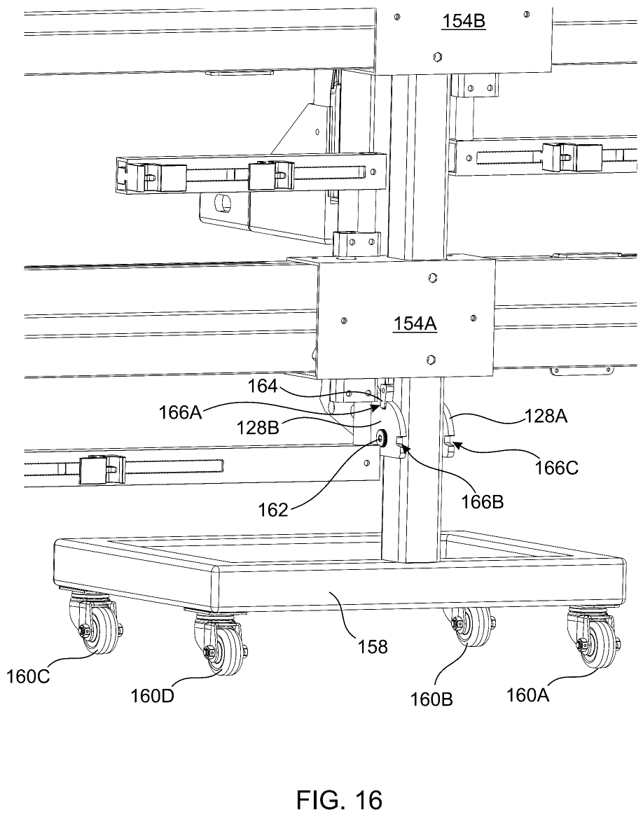

As best seen in FIG. 16, the horizontal arm 106 may pivot on a pivot pin 162, which passes through the stabilization plates 128A-B and the horizontal arm 106. The horizontal arm 106 may be secured in the desired position via a locking pin 164 (e.g., spring-loaded) configured to selectively engage a corresponding set of apertures 166A-D (some visible in FIG. 15) on stabilization plates 128A-B. In one example, the locking pin 164 may be actuated via a handle 168 (best seen in FIGS. 6 & 15). As shown, the handle 168 may pass through the horizontal arm 106 and be accessible at an end thereof, providing convenient access to a user. While described as a handle, any similar mechanism may work, such as a cable with a knob or hoop, or other mechanism. In other embodiments, the locking pin 164 may be actuated directly. In other words, a user may press or squeeze the locking pin 164 inward, thereby releasing it from a set of apertures 166A-D, allowing the horizontal arm 106 to pivot on the pivot pin 162. Once the locking pin 164 is aligned with a set of apertures, such as 166A and 166D, the locking pin 164 extends therein to thereby secure the horizontal arm 106 in position. While four apertures are illustrated, it will be appreciated that more may be used, allowing the horizontal arm 106 to be at varying angles in relation to the vertical arm 104. Additionally, as shown in FIGS. 15-16, each pedal post 136A-D may also pivot so as to facilitate easier transportation and/or storage of the vehicle-mounted rack 100.

In one method of use, a user inserts the hitch shank 102 into a hitch receiver of a vehicle and secures it therein using a standard hitch pin or similar hitch securement mechanism. To load cargo, such as bikes 132A-B, a user actuates the switch 118, which thereby initiates the motor 114, which rotates the threaded rod 110, causing the vertical arm 104 and horizontal arm 106 to lower. Once the horizontal arm 106 is proximal to, or abutting, the ground, a user may easily roll a bike onto the desired tire tray 150. A first pedal 148A is secured to the first pedal grip 134A and the second pedal 148B is secured to the second pedal grip 134B. With the bike 132A secured, a user may actuate the switch 118 to initiate the motor 114 in an opposite direction, which rotates the threaded rod 110 in the opposite direction, thereby raising the vertical arm 104 and horizontal arm 106, including the bike 132A thereon. When reaching the desired destination, a user may repeat the process to lower the vertical arm 104 and horizontal arm 106 once more to thereby easily remove the bike 132A.

Accordingly, it will be appreciated that the rack 100 disclosed herein solves the need for an adjustable bike rack that is electrically actuated, but does not rely on vehicle power, and that is capable of securing bikes regardless of frame and crossbar configuration, among other things.

While the forgoing examples are illustrative of the principles of the present invention in one or more particular applications, it will be apparent to those of ordinary skill in the art that numerous modifications in form, usage, and details of implementation can be made without the exercise of inventive faculty, and without departing from the principles and concepts of the invention. Accordingly, it will be appreciated that the terms “vertical” and “horizontal” are not to be considered limiting, but are simply to aid the reader in understanding general positioning, and that deviations from vertical and horizontal do not depart herefrom. Further, while the horizontal arm and vertical arm are shown and/or described as being generally perpendicular to one another, such an arrangement is not required. Indeed, as discussed in some embodiments, the horizontal arm may be tilted in relation to the vertical arm such that they are not perpendicular to one another. In some embodiments, the vertical arm may tilt downwardly toward the horizontal arm to allow easier access to a vehicle.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A rack mountable to a vehicle, comprising:
a hitch shank;
a vertical arm coupled to and extending upwardly from the hitch shank, the vertical arm configured to be positionable in relation to the hitch shank;
a horizontal arm coupled to and extending substantially perpendicular to the vertical arm;
a threaded rod disposed within the vertical arm, the threaded rod configured to move the vertical arm in relation to the hitch shank; and
a control box removably couplable to the vertical arm, the control box comprising one or more batteries and an electric motor configured to actuate the threaded rod.

2. The rack of claim 1, wherein the control box further comprises a battery status indicator and one or more switches to control the electric motor.

3. The rack of claim 1, further comprising one or more bike receiving members.

4. The rack of claim 3, wherein each bike receiving member comprises a tire tray and one or more pedal grips.

5. The rack of claim 4, wherein the one or more pedal grips comprise a pedal post having a keyed channel, and a top clamp and a bottom clamp each configured to slide in the keyed channel.

6. The rack of claim 1, further comprising a removably attachable base comprising one or more caster wheels.

7. A rack mountable to a vehicle, comprising:
a hitch shank configured to be insertable into a hitch receiver of the vehicle;
a first plate and a second plate coupled to the hitch shank and forming a threaded throat;
a vertical arm coupled to and configured to be slidable on the first and second plates;
a threaded rod disposed within the vertical arm, the threaded rod mating with the threaded throat; and
a horizontal arm coupled to and extending substantially perpendicular to the vertical arm via one or more stabilization plates;
wherein, when the threaded rod is actuated in a first direction, the vertical arm and horizontal arm move in a first direction, and when the threaded rod is actuated in a second, opposite direction, the vertical arm and horizontal arm move in a second, opposite direction.

8. The rack of claim 7, wherein the threaded rod is actuated via an electric motor.

9. The rack of claim 8, wherein the electric motor is housed within a control box, the control box comprising one or more batteries for powering the electric motor.

10. The rack of claim 9, wherein the control box further comprises a current restricting fuse configured to stop the electric motor when predetermined current thresholds are met or exceeded.

11. The rack of claim 9, wherein the control box further comprises a battery status indicator and one or more switches to control the electric motor.

12. The rack of claim 7, further comprising one or more bike receiving members.

13. The rack of claim 12, wherein each bike receiving member comprises a tire tray and one or more pedal grips.

14. The rack of claim 13, wherein the one or more pedal grips comprise a pedal post having a keyed channel, and a top clamp and a bottom clamp each configured to slide in the keyed channel.

15. A rack mountable to a vehicle, comprising:
a hitch shank configured to be insertable into a hitch receiver of the vehicle;
a vertical arm coupled to and configured to be positionable in relation to the hitch shank;
a horizontal arm coupled to and extending substantially perpendicular to the vertical arm;
one or more bike receiving members coupled to the horizontal arm; and
one or more pedal grips coupled to the one or more bike receiving members, respectively.

16. The rack of claim 15, wherein the one or more bike receiving members each comprise a tire tray comprising an aperture for receiving the horizontal arm, and a bracket for sliding over the tire tray, the bracket comprising an aperture for receiving the horizontal arm.

17. The rack of claim 15, wherein the one or more pedal grips each comprise a pedal post, a top clamp, and a bottom clamp, the top clamp and bottom clamp each slidable along the length of the pedal post.

18. The rack of claim 17, wherein the pedal post comprises a keyed channel.

19. The rack of claim 18, wherein the top clamp and bottom clamp are configured to be slidable within the keyed channel.

20. The rack of claim 19, wherein the top clamp and bottom clamp each comprise a release lock.
